(19) United States
(12) Patent Application Publication
(10) Pub. No.: US 2025/0150171 A1
(43) Pub. Date: May 8, 2025

(54) OPTICAL TRANSCEIVER, COMMUNICATION APPARATUS AND POWER SUPPLY CONTROL METHOD

(71) Applicant: NIPPON TELEGRAPH AND TELEPHONE CORPORATION, Tokyo (JP)

(72) Inventors: Hiroaki KATSURAI, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/839,711

(22) PCT Filed: Mar. 16, 2022
(86) PCT No.: PCT/JP2022/012061

§ 371 Date: Aug. 19, 2024

(51) Int. Cl. H04B 10/40; H04B 10/564

(52) U.S. Cl. CPC H04B 10/40; H04B 10/564

(57) ABSTRACT

An optical transceiver includes a reception unit, a transmission unit, and a power control circuit. The reception unit converts a reception signal from an optical signal into an electrical signal. The transmission unit converts a transmission signal from an electrical signal to an optical signal. The power control circuit switches whether to supply the power supplied from the power supply unit to the reception unit or the transmission unit on the basis of whether an optical signal is transmitted or received.

### TECHNICAL FIELD

The present invention relates to an optical transceiver, a communication device, and a power control method.

### BACKGROUND ART

An optical transceiver is used as a communication device that performs optical communication. FIG. 4 is a diagram illustrating a configuration of a reception unit of an optical transceiver. The optical transceiver illustrated in FIG. 4 is used in a 10G-PON (passive optical network) system (see, for example, Non Patent Literature 1). As illustrated in FIG. 4, the conventional optical transceiver has a configuration in which a transimpedance amplifier (TIA) and a limiting amplifier (LA) are used on the reception unit side.

### CITATION LIST

### Non Patent Literature

Non Patent Literature 1: Masafumi Nogawa, Hiroaki Katsurai, and Hiroshi Koizumi, “A 10G/1G Dual-rate Burst-mode Receiver for Next Generation Optical Access Networks”, NTT Technical Review, Vol. 12, No. 11, November 2014

### SUMMARY OF INVENTION

### Technical Problem

In order to reduce the power consumption of the optical transceiver, it is conceivable to adopt a configuration in which the LA is not used. In this case, in principle, it is necessary to narrow the range (dynamic range) of receivable input light intensity although the range also depends on the performance of the TIA. This can be mitigated depending on a usage scene. However, it is difficult to avoid a decrease in output amplitude at the time of inputting a small signal, and there is a problem that noise resistance is deteriorated. In addition, in order to save the power of the optical transceiver, it is also necessary to reduce a laser operation current at the time of transmission.

In view of the above circumstances, an object of the present invention is to provide an optical transceiver, a communication device, and a power control method capable of saving power while deterioration in reception quality is reduced.

### Solution to Problem

An optical transceiver according to an aspect of the present invention includes: a reception unit configured to convert a reception signal from an optical signal into an electrical signal; a transmission unit configured to convert a transmission signal from an electrical signal into an optical signal; and a power control circuit configured to switch whether to supply power supplied from a power supply unit to the reception unit or the transmission unit on the basis of whether an optical signal is transmitted or received.

A communication device according to an aspect of the present invention includes: the optical transceiver described above; a power supply unit configured to supply power to the optical transceiver; and a signal transmission unit configured to perform processing of outputting a transmission signal as an electrical signal to the optical transceiver and processing of receiving a reception signal as an electrical signal from the optical transceiver.

A power control method according to an aspect of the present invention includes a switching step of switching whether to supply power supplied from a power supply unit to a reception unit or a transmission unit of an optical transceiver on the basis of whether an optical signal is transmitted or received, the reception unit being configured to convert a reception signal from an optical signal to an electrical signal, the transmission unit being configured to convert a transmission signal from an electrical signal to an optical signal.

### Advantageous Effects of Invention

According to the present invention, it is possible to provide an optical transceiver capable of saving power while deterioration in reception quality is reduced.

### BRIEF DESCRIPTION OF DRAWINGS

FIG. 1 is a diagram illustrating a configuration of an optical transceiver according to an embodiment of the present invention.

FIG. 2 is a diagram illustrating a configuration of an optical communication system according to the embodiment.

FIG. 3 is a diagram illustrating a configuration of an optical communication system according to the embodiment.

FIG. 4 is a diagram illustrating a reception unit of a conventional optical transceiver.

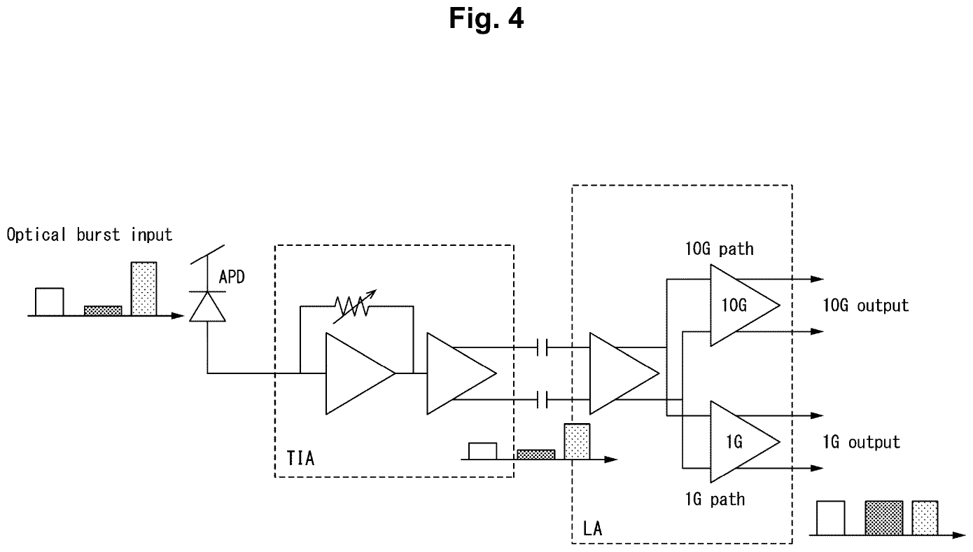

### DESCRIPTION OF EMBODIMENTS

Hereinafter, an embodiment of the present invention will be described in detail with reference to the drawings.

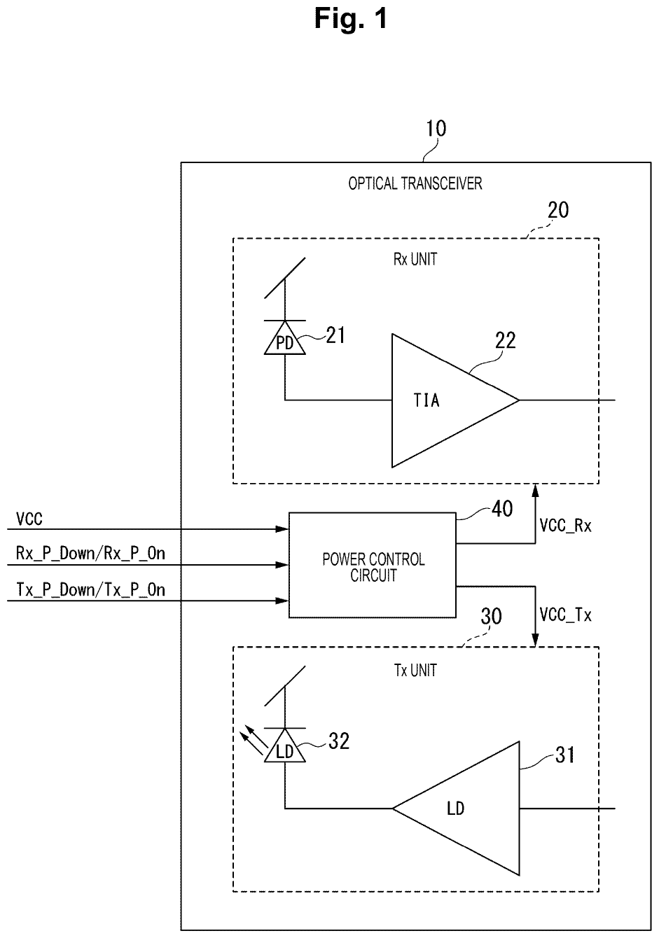

FIG. 1 is a diagram illustrating a configuration of an optical transceiver 10 (hereinafter, referred to as the TRx 10) according to the embodiment of the present invention. The TRx 10 includes a reception unit 20 (hereinafter, referred to as the Rx unit 20), a transmission unit 30 (hereinafter, referred to as the Tx unit 30), and a power control circuit 40. The Rx unit 20, the Tx unit 30, and the power control circuit 40 may be mounted on one chip or may be mounted on different chips.

The Rx unit 20 receives an optical signal. The Rx unit 20 includes a photodiode (PD) 21 and a TIA 22. The PD 21 receives an optical signal and converts the optical signal into a current signal. The TIA 22 converts the current signal into a voltage signal, amplifies the voltage signal, and outputs the voltage signal. The Tx unit 30 outputs an optical signal. The Tx unit 30 includes a laser diode (LD) 31 and an LD 32. The LD 31 generates a drive current from an electrical transmission signal. The LD 32 outputs light modulated by the drive current generated by the LD 31.

The power control circuit 40 inputs a power VCC. The power control circuit 40 supplies the input power VCC to the Rx unit 20 and the Tx unit 30. The power supplied to the Rx unit 20 is referred to as VCC_Rx, and the power supplied to the Tx unit 30 is referred to as VCC_Tx. Furthermore, the power control circuit 40 receives inputs of Rx_P_Down, Rx_P_On, Tx_P_Down, and Tx_P_On from the outside. Rx_P_Down is an instruction to turn off the power of the Rx unit 20. In a case where Rx_P_Down is input, the power control circuit 40 stops supplying VCC_Rx to the Rx unit 20. Rx_P_On is an instruction to turn on the power of the Rx unit 20. In a case where Rx_P_On is input, the power control circuit 40 starts supplying VCC_Rx to the Rx unit 20. Tx_P_Down is an instruction to turn off the power of the Tx unit 30. In a case where Tx_P_Down is input, the power control circuit 40 stops supplying VCC_Tx to the Tx unit 30. Tx_P_On is an instruction to turn on the power of the Tx unit 30. In a case where Tx_P_On is input, the power control circuit 40 starts supplying VCC_Tx to the Tx unit 30. Note that Rx_P_Down may also serve as Rx_P_On, and Tx_P_Down may also serve as Tx_P_On. For example, the positive logic of Rx_P_Down is an instruction to turn off the power of the Rx unit 20, and the negative logic is an instruction to turn on the power of the Rx unit 20. Similarly, for example, the positive logic of Tx_P_Down is an instruction to turn off the power of the Tx unit 30, and the negative logic is an instruction to turn on the power of the Tx unit 30. These logics may be reversed.

As described above, the power of the Rx unit 20 and the power of the Tx unit 30 are separated. The power control circuit 40 incorporated in the TRx 10 enables individual on-off control of the power to the Rx unit 20 and the power to the Tx unit 30 from the outside. When an optical signal is received, Tx_P_Down is input to the TRx 10. When Tx_P_Down is input, the power control circuit 40 stops supplying VCC_Tx to the Tx unit 30. When an optical signal is transmitted, Rx_P_Down is input to the TRx 10. When Rx_P_Down is received, the power control circuit 40 stops supplying VCC_Rx to the Rx unit 20.

By the above control, crosstalk noise is reduced. Therefore, deterioration in reception sensitivity can be minimized. In addition, since a temperature rise in the TRx 10 at the time of transmission can be suppressed, the operation current can be reduced.

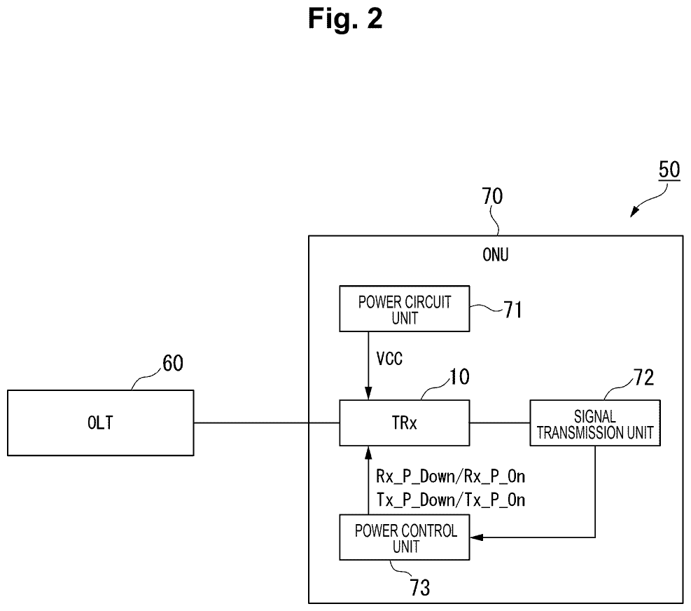

Next, an example of an optical communication system using the TRx 10 illustrated in FIG. 1 will be described. FIG. 2 is a diagram illustrating a configuration of an optical communication system 50 according to the present embodiment. The optical communication system 50 includes an OLT 60 and an ONU 70. The OLT 60 is an example of an office building side device. The ONU 70 is an example of a terminal side device. The OLT 60 and the ONU 70 are connected by an optical transmission line. The optical transmission line is, for example, an optical fiber. A direction from the OLT 60 to the ONU 70 is referred to as a downlink, and a direction from the ONU 70 to the OLT 60 is referred to as an uplink.

The ONU 70 includes a power circuit unit 71, the TRx 10, a signal transmission unit 72, and a power control unit 73. The power circuit unit 71 supplies the power VCC to each unit including the TRx 10. The Rx unit 20 of the TRx 10 receives an input of a downlink optical signal transmitted by the OLT 60 from the optical transmission line, converts the downlink optical signal into an electrical signal, and outputs the electrical signal to the signal transmission unit 72. The Tx unit 30 of the TRx 10 converts an uplink electrical signal addressed to the OLT 60 input from the signal transmission unit 72 into an optical signal and outputs the optical signal to the optical transmission line. The power control circuit 40 of the TRx 10 controls whether to supply the power VCC supplied from the power circuit unit 71 to the Rx unit 20 or the Tx unit 30 in accordance with an instruction from the signal transmission unit 72.

The signal transmission unit 72 performs reception processing of a reception signal converted into an electrical signal by the TRx 10. In addition, the signal transmission unit 72 outputs an electrical signal in which transmission data is set to the TRx 10. Furthermore, the signal transmission unit 72 turns on and off the power of each of the Rx unit 20 and the Tx unit 30 in the TRx 10 via the power control unit 73 on the basis of whether the ONU 70 receives or transmits an optical signal. Specifically, the signal transmission unit 72 turns on and off the power of each of the Rx unit 20 and the Tx unit 30 in the TRx 10 via the power control unit 73 according to a transmission timing and a reception timing of the ONU 70 allocated by the OLT 60. Alternatively, while normally keeping the Rx unit 20 operating, the signal transmission unit 72 turns off the power of the Rx unit 20 and turns on the power of the Tx unit 30 via the power control unit 73 in a case where there is transmission data. Alternatively, while periodically causing the Rx unit 20 to operate, the signal transmission unit 72 turns off the power of the Rx unit 20 and turns on the power of the Tx unit 30 via the power control unit 73 in a case where there is transmission data.

The power control unit 73 receives an instruction from the signal transmission unit 72, and turns on and off the power of each of the Rx unit 20 and the Tx unit 30. The power control unit 73 outputs Rx_P_Down to the TRx 10 in a case where the power of the Rx unit 20 is turned off, and outputs Rx_P_On to the TRx 10 in a case where the power of the Rx unit 20 is turned on. The power control unit 73 outputs Tx_P_Down to the TRx 10 in a case where the power of the Tx unit 30 is turned off, and outputs Tx_P_On to the TRx 10 in a case where the power of the Tx unit 30 is turned on.

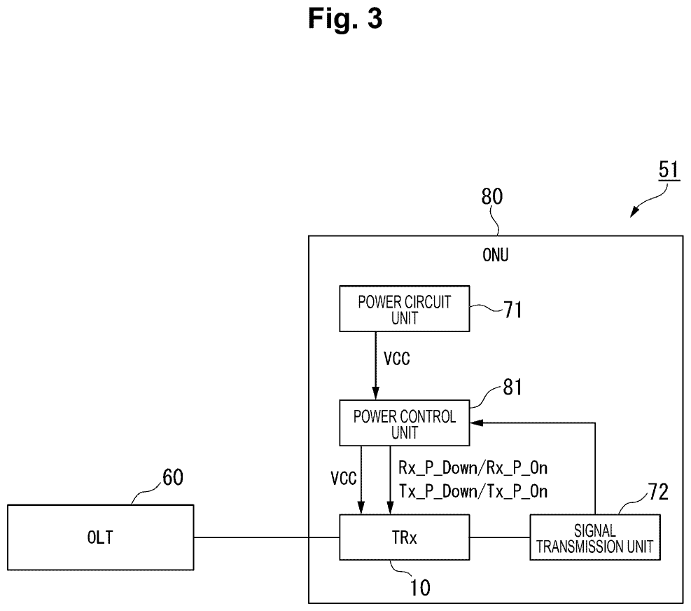

Note that the power circuit unit 71 may supply power to the TRx 10 via the power control unit. As a result, it is possible to control on and off of power supply to the TRx 10. FIG. 3 is a diagram illustrating a configuration of an optical communication system 51 according to the present embodiment. In FIG. 3, the same components as those of the optical communication system 50 illustrated in FIG. 2 are denoted by the same reference numerals, and the description thereof will be omitted. The optical communication system 51 illustrated in FIG. 3 is different from the optical communication system 50 illustrated in FIG. 2 in that an ONU 80 is provided instead of the ONU 70.

The ONU 80 includes the power circuit unit 71, the TRx 10, the signal transmission unit 72, and a power control unit 81. The power control unit 81 supplies the power VCC from the power circuit unit 71 to the TRx 10. The power control unit 81 turns on and off the supply of the power VCC to the TRx 10. In addition, the power control unit 81 receives an instruction from the signal transmission unit 72 and performs control similarly to the power control unit 73 illustrated in FIG. 2.

Next, operation examples of the optical communication systems 50 and 51 will be described. Operation Examples 1 to 3 will be described by use of the optical communication system 50, but the optical communication system 51 operates similarly.

### Operation Example 1

The OLT 60 of the optical communication system 50 allocates a transmission time and a reception time to the ONU 70. The signal transmission unit 72 of the ONU 70 turns on and off the power of each of the Rx unit 20 and the Tx unit 30 in the TRx 10 via the power control unit 73 according to the allocated transmission time and reception time. Specific operations will be described below.

The OLT 60 adds downlink schedule information indicating a scheduled transmission time of a next downlink signal to a downlink signal in which downlink data is set and transmits the downlink signal. The TRx 10 of the ONU 70 outputs the received downlink signal to the signal transmission unit 72. The signal transmission unit 72 acquires the downlink schedule information from the downlink signal.

The signal transmission unit 72 instructs the power control unit 73 to turn on the power of the Rx unit 20 at the scheduled transmission time indicated by the downlink schedule information. The power control unit 73 outputs Rx_P_On to the TRx 10 in accordance with the instruction from the signal transmission unit 72.

The TRx 10 receives the power VCC from the power circuit unit 71. In a case where Rx_P_On is input, the power control circuit 40 of the TRx 10 starts supplying VCC_Rx to the Rx unit 20. The Rx unit 20 receives the downlink optical signal from the OLT 60, converts the downlink optical signal into an electrical signal, and outputs the electrical signal to the signal transmission unit 72. In a case where the reception of the downlink signal is completed and the reception is successful, the signal transmission unit 72 instructs the power control unit 73 to turn off the power of the Rx unit 20. In a case where the downlink schedule information includes a scheduled transmission end time, the signal transmission unit 72 may instruct the power control unit 73 to turn off the power of the Rx unit 20 at the scheduled transmission end time. The power control unit 73 outputs Rx_P_Down to the TRx 10 on the basis of the instruction from the signal transmission unit 72. In a case where Rx_P_Down is input, the power control circuit 40 of the TRx 10 stops supplying VCC_Rx to the Rx unit 20.

In addition, the OLT 60 adds uplink schedule information indicating a transmission permission time of a next uplink signal to the downlink signal in which the downlink data is set and transmits the downlink signal. The TRx 10 of the ONU 70 outputs the received downlink signal to the signal transmission unit 72. The signal transmission unit 72 acquires the uplink schedule information from the downlink signal.

The signal transmission unit 72 instructs the power control unit 73 to turn on the power of the Tx unit 30 at the transmission permission time indicated by the uplink schedule information. The power control unit 73 outputs Tx_P_On to the TRx 10 in accordance with the instruction from the signal transmission unit 72.

As described above, the TRx 10 receives the power VCC from the power circuit unit 71. In a case where Tx_P_On is input, the power control circuit 40 of the TRx 10 starts supplying VCC_Tx to the Tx unit 30. The Tx unit 30 converts an uplink electrical signal input from the signal transmission unit 72 into an optical signal and transmits the optical signal to the OLT 60. In a case where the Tx unit 30 completes the transmission of the uplink signal and the transmission is successful, the signal transmission unit 72 instructs the power control unit 73 to turn off the power of the Tx unit 30. In a case where the uplink schedule information includes a transmission permission end time, the signal transmission unit 72 may instruct the power control unit 73 to turn off the power of the Tx unit 30 at the transmission permission end time. The power control unit 73 outputs Tx_P_Down to the TRx 10 on the basis of the instruction from the signal transmission unit 72. In a case where Tx_P_Down is input, the power control circuit 40 of the TRx 10 stops supplying VCC_Tx to the Tx unit 30.

As described above, the ONU 70 starts the power supply to the Rx unit 20 and stops the power supply to the Tx unit 30 at the scheduled time when the OLT 60 transmits an optical signal. In addition, the ONU 70 stops the power supply to the Rx unit 20 and starts the power supply to the Tx unit 30 at the transmission permission time allocated by the OLT 60.

### Operation Example 2

The ONU 70 of the optical communication system 50 normally keeps the Rx unit 20 operating and does not cause the Tx unit 30 to operate. The ONU 70 turns off the power of the Rx unit 20 and turns on the power of the Tx unit 30 in a case where there is transmission data. Specific operations will be described below.

The TRx 10 included in the ONU 70 receives the power VCC from the power circuit unit 71. Normally, the power control circuit 40 of the TRx 10 supplies the power VCC as VCC_Rx to the Rx unit 20, and does not supply power to the Tx unit 30. In a case where there is uplink transmission data, the signal transmission unit 72 waits for a timing at which no downlink signal from the OLT 60 is received, and instructs the power control unit 73 to turn off the power of the Rx unit 20. The power control unit 73 outputs Rx_P_Down to the TRx 10 in accordance with the instruction from the signal transmission unit 72. When Rx_P_Down is input, the power control circuit 40 of the TRx 10 stops supplying VCC_Rx to the Rx unit 20.

Furthermore, the signal transmission unit 72 instructs the power control unit 73 to turn on the power of the Tx unit 30. The power control unit 73 outputs Tx_P_On to the TRx 10 in accordance with the instruction from the signal transmission unit 72. When Tx_P_On is input, the power control circuit 40 of the TRx 10 starts supplying VCC_Tx to the Tx unit 30. The Tx unit 30 converts an uplink electrical signal output by the signal transmission unit 72 into an optical signal and transmits the optical signal to the OLT 60.

In a case where the Tx unit 30 completes the transmission of the uplink signal, the signal transmission unit 72 instructs the power control unit 73 to turn off the power of the Tx unit 30. The power control unit 73 outputs Tx_P_Down to the TRx 10 in accordance with the instruction from the signal transmission unit 72. When Tx_P_Down is input, the power control circuit 40 of the TRx 10 stops supplying VCC_Tx to the Tx unit 30.

Furthermore, the signal transmission unit 72 instructs the power control unit 73 to turn on the power of the Rx unit 20. The power control unit 73 outputs Rx_P_On to the TRx 10 in accordance with the instruction from the signal transmission unit 72. When Rx_P_On is input, the power control circuit 40 of the TRx 10 starts supplying VCC_Rx to the Rx unit 20.

As described above, while there is no transmission data, the ONU 70 supplies power to the Rx unit 20 and stops supplying power to the Tx unit 30. In addition, in a case where there is transmission data, the ONU 70 supplies power to the Tx unit 30 and stops supplying power to the Rx unit 20 until transmission of the transmission data ends.

### Operation Example 3

The ONU 70 of the optical communication system 50 periodically causes the Rx unit 20 to operate. The ONU 70 turns off the power of the Rx unit 20 and turns on the power of the Tx unit 30 in a case where there is transmission data.

When a periodic operation start time of the Rx unit 20 comes, the signal transmission unit 72 of the ONU 70 instructs the power control unit 73 to turn on the power of the Rx unit 20. The power control unit 73 outputs Rx_P_On to the TRx 10 in accordance with the instruction from the signal transmission unit 72. When Rx_P_On is input, the power control circuit 40 of the TRx 10 starts supplying VCC_Rx to the Rx unit 20. In a case where a downlink optical signal from the OLT 60 is received, the Rx unit 20 converts the downlink optical signal into an electrical signal, and outputs the electrical signal to the signal transmission unit 72.

When a periodic operation end time of the Rx unit 20 comes, the signal transmission unit 72 instructs the power control unit 73 to turn off the power of the Rx unit 20. The power control unit 73 outputs Rx_P_Down to the TRx 10 in accordance with the instruction from the signal transmission unit 72. When Rx_P_Down is input, the power control circuit 40 of the TRx 10 stops supplying VCC_Rx to the Rx unit 20. The ONU 70 periodically causes the Rx unit 20 to operate as described above.

In a case where there is uplink transmission data, the signal transmission unit 72 instructs the power control unit 73 to turn on the power of the Tx unit 30 after waiting until an operation period of the Rx unit 20 ends and the power of the Rx unit 20 is turned off. Note that, in a case where the current time is not in the operation period of the Rx unit 20, the signal transmission unit 72 instructs the power control unit 73 to turn on the power of the Tx unit 30 without waiting. The subsequent operation of the ONU 70 is similar to Operation Example 2 in a case where there is uplink transmission data. That is, the power control unit 73 outputs Tx_P_On to the TRx 10. The power control circuit 40 of the TRx 10 starts supplying VCC_Tx to the Tx unit 30. The Tx unit 30 converts an uplink electrical signal output by the signal transmission unit 72 into an optical signal and transmits the optical signal to the OLT 60. In a case where the Tx unit 30 completes the transmission of the uplink signal, the signal transmission unit 72 instructs the power control unit 73 to turn off the power of the Tx unit 30. The power control unit 73 outputs Tx_P_Down to the TRx 10. The power control circuit 40 of the TRx 10 stops supplying VCC_Tx to the Tx unit 30.

After turning off the power of the Tx unit 30, the ONU 70 performs the above processing to turn on the power of the Rx unit 20 in a case where the periodic operation start time of the Rx unit 20 comes. Note that, in a case where there is uplink transmission data, the ONU 70 may turn off the power of the Rx unit 20 and turn on the power of the Tx unit 30 even before the end of the periodic operation period of the Rx unit 20.

As described above, the ONU 70 periodically supplies power to the Rx unit 20 and stops supplying power to the Tx unit 30 during a certain period. In addition, in a case where there is transmission data, the ONU 70 supplies power to the Tx unit 30 after the end or stop of the certain period until the end of transmission of the transmission data.

In the case of the optical communication system 51, the operation of the power control unit 73 in Operation Examples 1 to 3 described above is performed by the power control unit 81. However, the TRx 10 is supplied with the power VCC via the power control unit 81.

### Operation Example 4

When both the Rx unit 20 and the Tx unit 30 are off, the ONU 80 of the optical communication system 51 turns off the power VCC to be supplied to the TRx 10. That is, the power control unit 81 of the ONU 80 does not supply the power VCC received from the power circuit unit 71 to the TRx 10 during a period from reception of Rx_P_Down and Tx_P_Down to reception of either Rx_P_On or Tx_P_On. As a result, the standby power of the power control circuit 40 can also be reduced. Operation Example 4 can also be combined with Operation Examples 1 to 3 described above.

As described above, the TRx 10 of the present embodiment achieves power saving by causing the Rx unit 20 and the Tx unit 30 to individually operate.

For example, in a passive optical network (PON), a Rx unit and a Tx unit are caused to individually operate, and sleep control is performed. However, in the case of PON, the operations of the Rx unit and the Tx unit are considered to be independent (irrelevant). Therefore, it is assumed that the operation of temporarily stopping the Tx unit is not performed during the operation of the Rx unit to suppress crosstalk.

For example, in the case of PON, time allocation is performed in uplink, which is a direction from an ONU to an OLT, whereas transmission is performed at any timing in downlink, which is a direction from the OLT to the ONU. Each ONU selects and receives only data addressed to its own device among received downlink data by decryption. That is, an allocation time of uplink data transmission to each ONU and a reception timing of each ONU are irrelevant. Therefore, in order to suppress crosstalk, it is necessary to incorporate, into an existing control system, a mechanism in which the OLT allocates a transmission time to an ONU (DBA) while avoiding a data reception timing of the ONU. Therefore, the processing is complicated. On the other hand, in the present embodiment, the Rx unit 20 and the Tx unit 30 whose powers are controlled are on a one-to-one basis, which is relatively easy to implement.

According to the above-described embodiment, a communication device includes an optical transceiver, a power supply unit, and a signal transmission unit. The communication device is, for example, the ONUs 70 and 80 in the embodiment. The power supply unit supplies power to the optical transceiver. The power supply unit is, for example, the power circuit unit 71 in the embodiment. The signal transmission unit performs processing of outputting a transmission signal as an electrical signal to the optical transceiver and processing of receiving a reception signal as an electrical signal from the optical transceiver.

The optical transceiver includes a reception unit, a transmission unit, and a power control circuit. The reception unit converts a reception signal from an optical signal into an electrical signal. The transmission unit converts a transmission signal from an electrical signal to an optical signal. The power control circuit switches whether to supply the power supplied from the power supply unit to the reception unit or the transmission unit on the basis of whether an optical signal is transmitted or received. The power control circuit is, for example, the power control circuit 40 in the embodiment.

In a case where an optical signal is received, the power control circuit stops supplying the power to the transmission unit and supplies the power to the reception unit. Furthermore, in a case where an optical signal is transmitted, the power control circuit stops supplying the power to the reception unit and supplies the power to the transmission unit.

The power control circuit may stop supplying the power to the transmission unit and supply the power to the reception unit periodically during a certain period or during a period from a time when a communication destination device is scheduled to transmit an optical signal until reception of the optical signal ends. Furthermore, in a case where transmission data is generated, the power control circuit may supply the power to the transmission unit after the period in which the power is supplied to the reception unit ends.

The communication device may further include a control unit. The control unit stops supplying the power from the power supply unit to the optical transceiver during a period in which transmission and reception of an optical signal by the optical transceiver are not performed. The control unit is, for example, the power control unit 81 in the embodiment.

Although the embodiment of the present invention has been described in detail with reference to the drawings, the specific configuration is not limited to the embodiment, and includes design and the like within a range not departing from the gist of the present invention.

### REFERENCE SIGNS LIST

10 Optical transceiver
20 Reception unit (Rx unit)
30 Transmission unit (Tx unit)
40 Power control circuit
50, 51 Optical communication system
71 Power circuit unit
72 Signal transmission unit
73 Power control unit
81 Power control unit

1. An optical transceiver comprising:
a reception circuit configured to convert a reception signal from an optical signal into an electrical signal;
a transmission circuit configured to convert a transmission signal from an electrical signal into an optical signal; and
a power control circuit configured to switch whether to supply power supplied from a power supply circuit to the reception circuit or the transmission circuit on a basis of whether an optical signal is transmitted or received.

2. The optical transceiver according to claim 1, wherein
the power control circuit stops supplying the power to the transmission circuit and supplies the power to the reception circuit in a case where an optical signal is received, and stops supplying the power to the reception circuit and supplies the power to the transmission unit in a case where an optical signal is transmitted.

3. The optical transceiver according to claim 2, wherein
the power control circuit stops supplying the power to the transmission circuit and supplies the power to the reception circuit periodically during a certain period or during a period from a time when a communication destination device is scheduled to transmit an optical signal until reception of the optical signal ends.

4. The optical transceiver according to claim 3, wherein
in a case where transmission data is generated, the power control circuit supplies the power to the transmission circuit after the period in which the power is supplied to the reception circuit ends.

5. A communication device comprising:
the optical transceiver according to claim 1;
a power supply circuit configured to supply power to the optical transceiver;
and a signal transmission circuit configured to perform processing of outputting a transmission signal as an electrical signal to the optical transceiver and processing of receiving a reception signal as an electrical signal from the optical transceiver.

6. The communication device according to claim 5, further comprising
a controller configured to stop supplying the power from the power supply circuit to the optical transceiver during a period in which transmission and reception of an optical signal by the optical transceiver are not performed.

7. A power control method comprising:
a switching step of switching whether to supply power supplied from a power supply unit to a reception unit or a transmission unit of an optical transceiver on a basis of whether an optical signal is transmitted or received, the reception unit being configured to convert a reception signal from an optical signal to an electrical signal, the transmission unit being configured to convert a transmission signal from an electrical signal to an optical signal.

8. The power control method according to claim 7, further comprising
a control step of stopping supplying the power from the power supply unit to the optical transceiver during a period in which transmission and reception of an optical signal by the optical transceiver are not performed.
